(19) United States
(12) Patent Application Publication
(10) Pub. No.: US 2011/0240787 A1
(43) Pub. Date: Oct. 6, 2011

(54) LOCKING MECHANISM FOR A SEAT BELT

(76) Inventor: Kuo-Hao LEE, Taipei (TW)

(21) Appl. No.: 13/160,059

(22) Filed: Jun. 14, 2011

Related U.S. Application Data
(63) Continuation-in-part of application No. 12/319,743, filed on Jan. 12, 2009.

(30) Foreign Application Priority Data
Dec. 8, 2008 (TW) 097221939

(51) Int. Cl. B60R 22/40; B60R 22/36

(52) U.S. Cl. 242/384.6

(57) ABSTRACT

A locking mechanism for a seat belt has a case, a locking set and a sensor. The case is mounted adjacent to a side of a retractor having a shaft and the case is mounted around the shaft and has a flat support inside the case and at least one opening being formed on the bottom. The flat support has at least one hole formed therethrough. The locking set is mounted on the shaft. The sensor has a steel ball and a rod. The steel ball is detachably disposed on the flat support and the rod is pivotally mounted in the case and is disposed on the steel ball. If muddy water, sand or dirt enters the locking mechanism, muddy water, sand or dirt can fall through the at least one hole of the flat support and the at least one opening thus avoiding muddy water, sand or dirt affecting the locking mechanism.

### CROSS-REFERENCE TO RELATED APPLICATIONS

This application is a continuation-in-part application of U.S. patent application Ser. No. 12/319,743, filed Jan. 12, 2009, the entirety of which is herein incorporated by reference.

### BACKGROUND OF THE INVENTION

1. Field of the Invention

The present invention relates to a locking mechanism for a seat belt, more particularly to a locking mechanism that stops the belt from spooling out when the belt is pulled fast or the vehicle experiences a sudden change in velocity. This particular invention allows muddy water, sand or dirt to fall out of or exit the mechanism and thus prevents the accumulation from sticking to the mechanism and unpredictable dangers.

2. Description of Related Art

With reference to the FIG. 6, a conventional locking mechanism for a seat belt has a case, a locking set (70), a sensor (80) and a lid. The case is hollow and composed of a base (60) and a lid. The base (60) has a lower segment and a mount (61) mounted on the lower segment. The locking set (70) has a ratchet wheel (71) mounted on a shaft of an inertia reel and an inertia plate mounted on the ratchet wheel (71). The sensor (80) has a steel ball (81) disposed detachably on the mount (61) and a rod (82). The rod (82) is pivotally mounted in the case and disposed on the steel ball (81) and has an edge and a pawl (821) formed on the edge. The pawl (821) of the rod (82) can engage the ratchet wheel (71) and lock the ratchet wheel (71) by movement of the steel ball (81) when outside conditions change, like deceleration or rollover. Therefore the seat belt shall be locked for protection.

The seat belt can be applied in several kinds of vehicles such as dune buggies or All Terrain Vehicles. However, if driven on sand, mud, or riverbeds, then it is possible that muddy water, sand or dirt might enter the locking mechanism. Once sand or dirt enters the locking mechanism, the sand or dirt may accumulate on the mount (61) and stick to the steel ball (81) or the rod (82) of the locking mechanism so losing the efficacy of the locking mechanism and causing an unpredictable danger. In particular, muddy water drying to a solid deposit may inhibit the locking mechanism.

With reference to FIG. 7, U.S. Pat. No. 4,603,819 discloses another locking mechanism for the seat belt. The locking mechanism comprises a cup member (102) being carried at a lower edge of a support (not numbered) and defines an upwardly opening depression (104) in which an inertia weight (106) such as a stainless steel ball is mounted. However, sand, dust, mud, etc. will accumulate in the cup member (102) easily because the sidewall of the upwardly opening depression (104) will hold these accumulations (200). As the accumulations (200) gradually fill the cup member (102), the inertia weight (106) will be eventually surrounded by the accumulations (200) and become unmovable. When the inertia weight (106) becomes unmovable, it will lose its function. Even though a bottom opening (108) is defined in the cup member (102), the bottom opening (108) is relatively small and blocked by the inertia weight (106). To overcome the shortcomings, the present invention allows sand or dirt to fall out of the locking mechanism in order to mitigate or obviate the aforementioned problems.

### SUMMARY OF THE INVENTION

The main objective of the invention is to allow muddy water, sand or dirt to fall out of the locking mechanism, and so, prevent muddy water, sand or dirt accumulation within that mechanism.

A locking mechanism for a seat belt has a case, a locking set and a sensor. The case is mounted adjacent to a side of a retractor having a shaft and the case is mounted around the shaft and has a mount inside the case and at least one opening being formed on the bottom. The mount has at least one hole formed therethrough. The locking set is mounted on the shaft. The sensor has a steel ball and a rod. The steel ball is detachably disposed on the mount and the rod is pivotally mounted in the case and is disposed on the steel ball. If muddy water, sand or dirt enters the locking mechanism, muddy water, sand or dirt can fall through the at least one hole of the mount and the at least one opening thus avoiding muddy water, sand or dirt affecting the locking mechanism.

Other objectives, advantages and novel features of the invention will become more apparent from the following detailed description when taken in conjunction with the accompanying drawings.

### BRIEF DESCRIPTION OF THE DRAWINGS

FIG. 1 is a partially exploded perspective view of a locking mechanism in accordance with the present invention;

FIG. 2 is front view in partial section of a third embodiment of the locking mechanism;

FIG. 3 is a partial front view of the locking mechanism in FIG. 1 shown locked;

FIG. 4 is an operational front view in partial section of the locking mechanism in FIG. 1 shown with accumulation falling out;

FIG. 5 is a perspective view of the flat support in accordance with the present invention;

FIG. 6 is a front view in partial section of a conventional locking mechanism; and

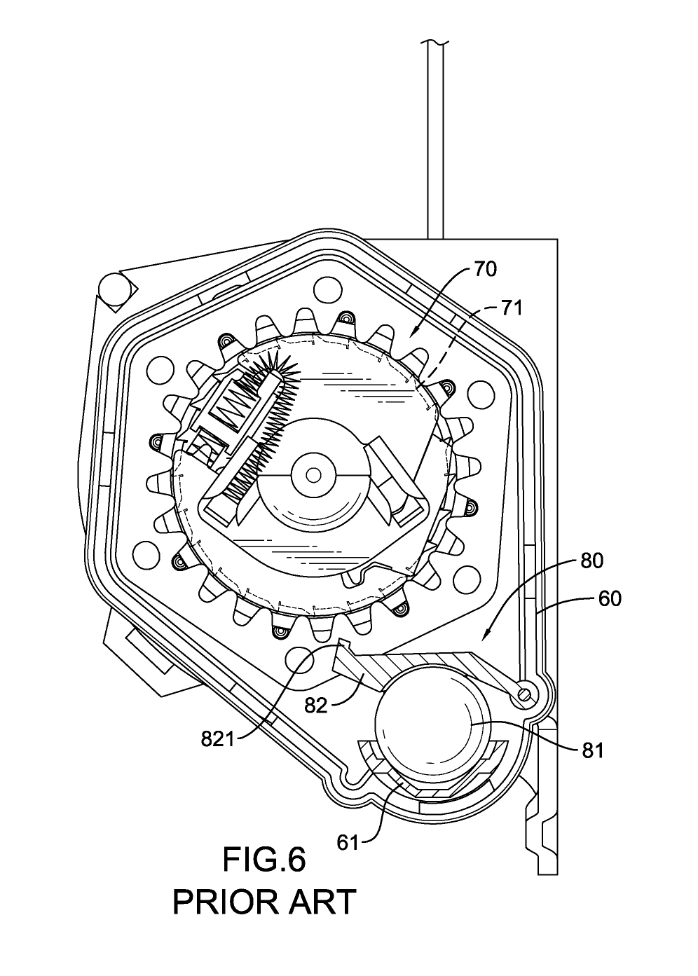

FIG. 7 is a cross view of a conventional locking mechanism for a seat belt disclosed in U.S. Pat. No. 4,603,819.

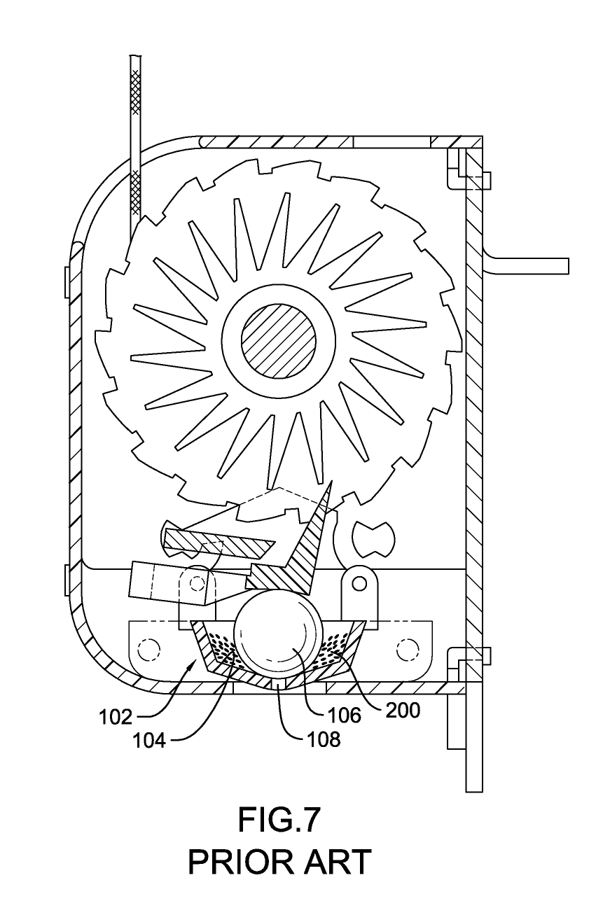

### DETAILED DESCRIPTION OF PREFERRED EMBODIMENT

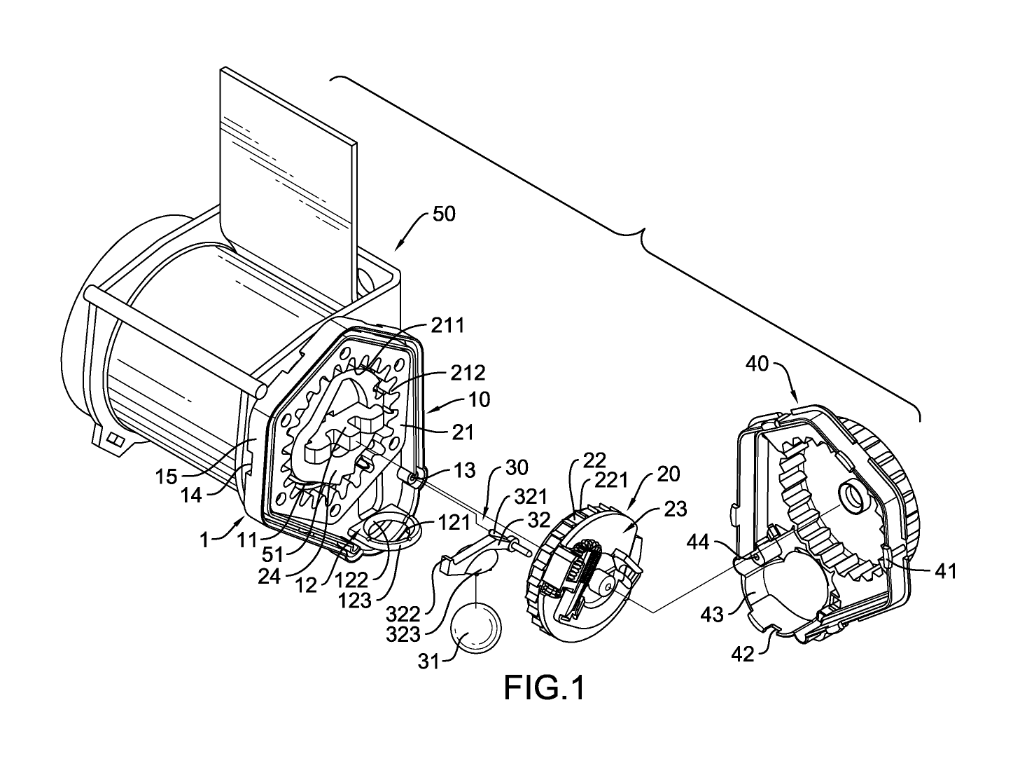

With reference to FIG. 1, a locking mechanism for a seat belt is mounted adjacent to a side of a retractor (50) having a shaft (51) protruding out of the retractor (50) and the locking mechanism is mounted around the shaft (51) and comprises a case (1), a locking set (20) and a sensor (30).

The case (1) is mounted adjacent to the side of the retractor (50) and has a bottom, a chamber defined inside the case (1), a side, a pivot hole (11), a flat support (12) and at least one opening (42), and may be composed of a base (10) with a lower segment and a lid (40). The side of the case (1) is adjacent to the side of the retractor (50) and may further be formed on the base (10). The pivot hole (11) is formed on the side of the base (1) and around the shaft (51) of the retractor (50).

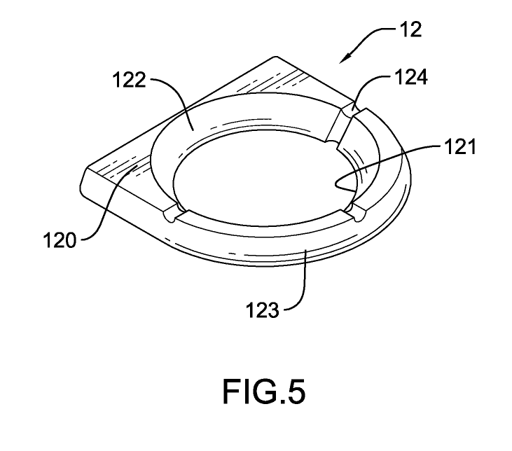

With further reference to FIG. 5, the flat support (12) is attached inside the chamber and may be separately mounted or integrally formed on the lower segment of the base (10) and has a flat body, a top surface (120), and at least one hole (121), and may further have an inner surface (122), an annular outer surface (123) and at least one groove (124). The inner surface (122) of the at least one hole (121) is an inclined surface and downwardly tapered. The annular outer surface (123) of the flat body is formed around the outer periphery of the flat body and is an inclined surface. The at least one groove (124) is formed in the inner surface (122) and further extends to the top surface (120) of the flat body.

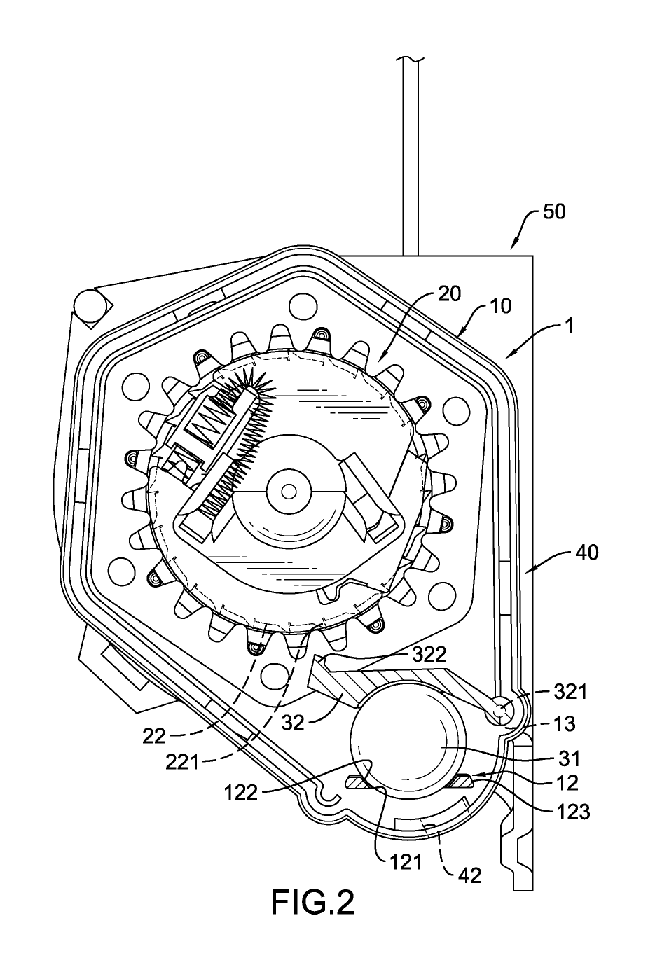

With further reference to FIG. 2, the at least one opening (42) is formed on the bottom of the case (1). The base (10) may further have an inner side, a pivot slot (13) formed on the inner side, an annular edge (15) and at least one connector (14) formed on the annular edge (15). The lid (40) is mounted on the base (10) and may have an inner side, a pivot slot (44) formed on the inner side, an annular edge (43) and at least one connector (41). The lid (40) may be mounted on the base (10) with the at least one connectors (14, 41) engaging each other. The at least one opening (42) may be formed through the annular edge (15) of the base (10) or the annular edge (43) of the lid (40) and may be better to further be formed under the flat support (12).

The locking set (20) is mounted inside the chamber of the case (1) and has a ring (21), a pawl locking (24), a ratchet wheel (22), and an inertia plate (23). The ring (21) is mounted on the inner side of the base (10) to allow the shaft (51) to protrude through and has an interior surface (211) and interior teeth (212) formed on the interior surface (211). The pawl locking (24) is mounted on and connects with the shaft (51). The pawl locking (24) has an exterior surface and exterior teeth formed on the exterior surface. The exterior teeth can selectively engage the interior teeth (212). The ratchet wheel (22) is mounted on and connects with the shaft (51). The ratchet wheel (22) has an annular surface and teeth (221) formed on the annular surface. The inertia plate (23) is mounted in the ratchet wheel (22).

The sensor (30) has a steel ball (31) and a rod (32). The steel ball (31) is detachably disposed on the inner surface (122) of the flat support (12). The rod (32) has two ends opposite to each other, an axle (321) formed on one end and a pawl (322) formed on the opposite end, and may further have a side and a hood (323) formed on the side. The rod (32) is pivotally mounted in the pivot slot (13, 44) of the base (10) and the lid (40) with the axle (321). The rod (32) is disposed on the steel ball (31) and may be disposed on the steel ball (31) by the hood (323). The pawl (322) can selectively engage the teeth (221) of the ratchet wheel (22) by the movement of steel ball (31) when outside conditions change, like deceleration or rollover.

The retractor (50) and the locking mechanism are usually mounted in vehicles. Normally, the webbing of seat belt can be pulled out slowly by the shaft (51) rotating with the pawl locking (24) and the ratchet wheel (22). If the webbing of seat belt is pulled fast, the shaft (51) is pulled to move and the exterior teeth of the pawl locking (24) move to engage the interior teeth (212) of the ring (21). The engagement of the exterior teeth and the interior teeth makes the shaft (51) stop rotating.

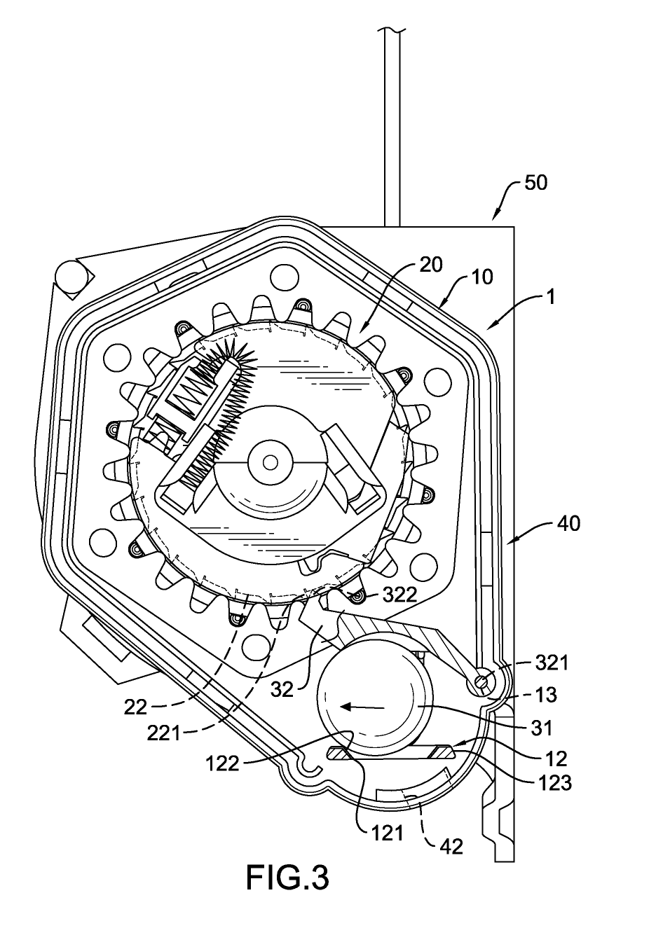

The pawl (322) of the rod (32) does not normally engage the teeth (221). With further reference to FIG. 3, if the vehicle undergoes a sudden change of acceleration, like car crash, sudden deceleration, or rollover, the steel ball (31) will move out of the inner surface (122) of the flat support (12) and lift the rod (32) to make the pawl (322) engage the teeth (221). With the engagement of the pawl (322) and the teeth (221), the pawl (322) of the rod (32) locks the ratchet wheel (22) and makes the shaft (51) stop to prevent the webbing of seat belt from being pulled out, thus restraining the occupant for safety.

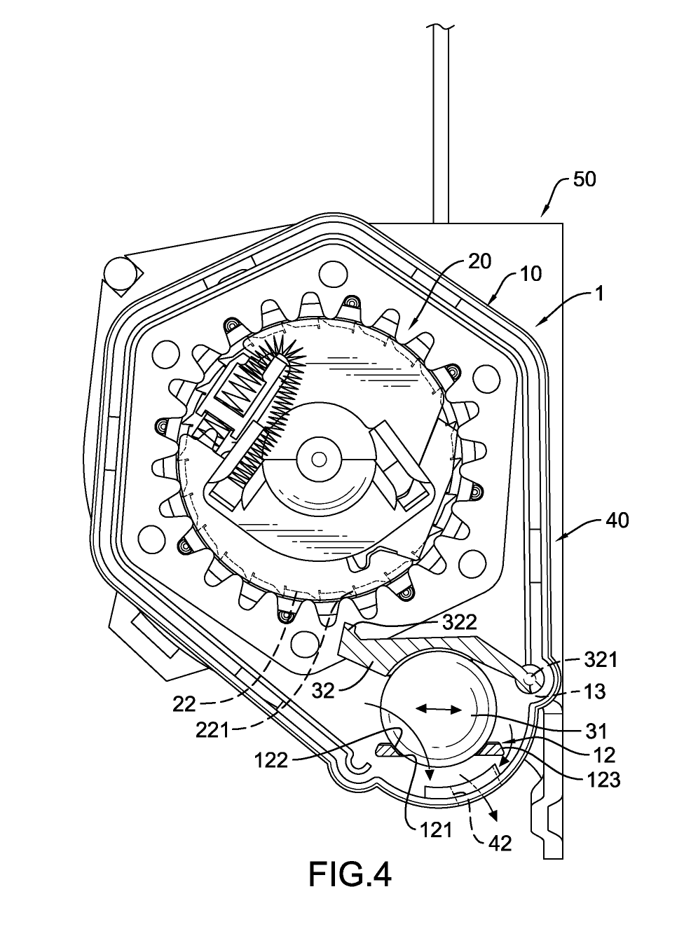

With reference to FIG. 4, when the vehicle travels on sand, mud or riverbed, then sand, dirt or muddy water might enter into the locking mechanism and form an accumulation on the bottom of the case (1) or the inner surface (122) of the flat support (12). The accumulation on the flat support (12) or the bottom of the case (1) may affect the position of the steel ball (31), the rod (32) or even the whole locking mechanism. The movement of the vehicle, which vibrates the steel ball (31), causes the accumulation on the flat support (12) to drop down through the at least one hole (121) or the annular surface (123), or the groove (124) formed in the inner surface (122) and the top surface (120) of the flat body. Therefore, the accumulation drops out of the bottom of the case (1) and falls out from the at least one opening (42). In comparison to the conventional cup-shaped structure, because the at least one opening (42) is formed in the flat body, the flat support (12) will evacuate sand, dirt, dust, etc from the case easily. Because of such flat design, the accumulation would not affect the working of the locking mechanism so that members of the locking mechanism would not be stuck. Therefore, the present invention prevents unpredictable danger when the steel ball (31) is in an irregular position.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A locking mechanism for a seat belt being mounted adjacent to a retractor having a shaft protruding out of the retractor and the locking mechanism mounted around the shaft, the locking mechanism comprising:
a case mounted adjacent to the retractor and having
a bottom;
a side being adjacent to the retractor;
a pivot hole formed on the side and around the shaft of the retractor;
a flat support mounted inside the case and having a flat body and at least one hole formed through the flat body; and
at least one opening formed through the bottom of the case;
a locking set mounted on the shaft inside the case and having a ratchet wheel with teeth; and
a sensor mounted inside the case and having
a steel ball detachably disposed on the flat support; and
a rod pivotally mounted inside the case and disposed on the steel ball and having
two ends opposite to each other; and
a pawl formed on one end and selectively engaging the teeth of the ratchet wheel.

2. The locking mechanism as claimed in claim 1, wherein the case has
a base mounted adjacent to the retractor and having the side and the pivot hole being formed through the side; and
a lid mounted on the base.

3. The locking mechanism as claimed in claim 2, wherein the lid has an annular edge and the annular edge has a bottom through which the at least one opening is formed.

4. The locking mechanism as claimed in claim 2, wherein the base has an annular edge and the annular edge has a bottom through which the at least one opening is formed.

5. The locking mechanism as claimed in claim 1, wherein the at least one hole of the flat body further has an inclined inner surface being downwardly tapered; and the flat body further has an outer periphery being an annular and inclined surface.

6. The locking mechanism as claimed in claim 2, wherein the at least one hole of the flat body further has an inclined inner surface being downwardly tapered; and the flat body further has an outer periphery being an annular and inclined surface.

7. The locking mechanism as claimed in claim 3, wherein the at least one hole of the flat body further has an inclined inner surface being downwardly tapered; and the flat body further has an outer periphery being an annular and inclined surface.

8. The locking mechanism as claimed in claim 4, wherein the at least one hole of the flat body further has an inclined inner surface being downwardly tapered; and the flat body further has an outer periphery being an annular and inclined surface.

9. The locking mechanism as claimed in claim 5, wherein the flat body has a top surface and at least one groove is further formed in the inner surface and extends to the top surface.

10. The locking mechanism as claimed in claim 6, wherein the flat body has a top surface and at least one groove is further formed in the inner surface and extends to the top surface.

11. The locking mechanism as claimed in claim 7, wherein the flat body has a top surface and at least one groove is further formed in the inner surface and extends to the top surface.

12. The locking mechanism as claimed in claim 8, wherein the flat body has a top surface and at least one groove is further formed in the inner surface and extends to the top surface.

13. The locking mechanism as claimed in claim 9, wherein the rod further has a side and a hood formed on the side, and the hood is disposed on the steel ball.

14. The locking mechanism as claimed in claim 10, wherein the rod further has a side and a hood formed on the side, and the hood is disposed on the steel ball.

15. The locking mechanism as claimed in claim 11, wherein the rod further has a side and a hood formed on the side, and the hood is disposed on the steel ball.

16. The locking mechanism as claimed in claim 12, wherein the rod further has a side and a hood formed on the side, and the hood is disposed on the steel ball.
